(19) United States
(12) Patent Application Publication
(10) Pub. No.: US 2006/0204138 A1
(43) Pub. Date: Sep. 14, 2006

(54) Image scaling device using a single line memory and a scaling method thereof

(75) Inventor: Yun-Hye Yim, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/363,734

(22) Filed: Feb. 28, 2006

(30) Foreign Application Priority Data
Mar. 14, 2005 (KR) 10-2005-21068

(51) Int. Cl. G06K 9/32; H04N 1/393; H04N 5/44; G09G 5/00

(52) U.S. Cl. 382/298; 345/660; 348/561; 358/451

(57) ABSTRACT

An image scaling device and scaling method for scaling down image data by using a single line memory are provided. The image scaling device includes: a pre-scaling unit for receiving first data of M lines each of the M lines having L pixel data, calculating a first average value for every 2^{k} pixel data in each of the M lines, and calculating a second average value for every 2^{k} first average values according to a pre-scaling ratio, wherein L, M and k are positive integers; a line memory for storing the first average value calculated at the pre-scaling unit and second data; and a main-scaling unit for receiving the second average value from the pre-scaling unit and the second data stored in the line memory and performing a filtering operation on the second average value and the second data by using a linear-interpolation according to a main-scaling ratio, wherein 2^{k} is smaller than a total number of pixel data in one M line and a total number of the M lines.

### BACKGROUND OF THE INVENTION

1. Technical Field

The present invention relates to an image scaling device, and more particularly, to an image scaling device and a scaling method for scaling down image data by using a single line memory.

2. Discussion of the Related Art

Recently, a mobile terminal having a camera module such as a camera phone has become increasingly popular. For example, a large percentage of mobile phones now being sold have built-in cameras. One feature which has led to the proliferation of camera phones is the increased resolution of the camera module. To provide a camera module with an increased resolution, a highly integrated chip such as an image scaler must be included in a system-on-chip embedded in the camera phone.

The image scaler is used to scale down a high-quality image. To do this, a high-quality image algorithm, which includes a low pass filtering process, is performed. If, however, the low pass filtering is not performed, image quality may be seriously degraded. For example, the edges of an image may be distorted and aliasing may occur.

To prevent image distortion and aliasing, the low pass filtering blurs the color of the edges of objects where high frequency components are concentrated by obtaining an average value of the color or by assigning different weights to the edges of objects which are distinguishable from peripheral background images. By doing this, the low pass filtering makes the color of the edges similar to a peripheral background, thereby preventing the occurrence of aliasing or image distorting noise.

Although the low pass filtering provides an improved image quality as compared to that of an image processed by interpolation only, the low pass filtering is performed after an image has been scaled down. Thus, the low pass filtering requires at least two or more additional line memories. Therefore, a manufacturing cost of such an image scaler increases and the integrity of a system-on-chip including the image scaler is reduced.

Accordingly, a need exists for an image scaling device that is capable of providing high-quality images while having a configuration that reduces manufacturing costs and increases the integrity of a system-on-chip including the image scaler.

### SUMMARY OF THE INVENTION

The present invention provides an image scaling device and a scaling method for scaling down image data by performing a low pass filtering and an interpolation by using a single line memory.

An embodiment of the present invention provides an image scaling device that includes a pre-scaling unit for receiving first data of a plurality of M lines each of the M lines having a plurality of L pixel data, calculating a first average value for every 2^{k} pixel data in each of the M lines, and calculating a second average value for every 2^{k} first average values according to a pre-scaling ratio, wherein L, M and k are positive integers; a line memory for storing the first average value calculated at the pre-scaling unit and second data; and a main-scaling unit for receiving the second average value from the pre-scaling unit and the second data stored in the line memory and performing a filtering operation on the second average value and the second data by using a linear interpolation according to a main-scaling ratio, wherein 2^{k} is smaller than a total number of pixel data in one M line and a total number of the M lines.

The pre-scaling ratio and the main-scaling ratio are determined by an image scaling ratio (1/N), wherein the image scaling ratio (1/N) is (1/2^{k})×(2^{k}/N) and k and N are integers. The value of 2k/N may be satisfied by a condition 2k/N≦1.

The main-scaling unit includes: a memory access controller for storing or reading the second data to/from the line memory; an address controller for outputting an address of the line memory in response to data information from the memory access controller; and an interpolation unit for receiving the second data from the memory access controller and the second average value from the pre-scaling unit, performing the filtering operation by using the linear interpolation according to the main scaling ratio and storing the second average value in the line memory as the second data.

The first data is directly inputted to the main scaling unit when the image scaling ratio 1/N is smaller than 1 and larger than 1/2. The interpolation unit receives the first data and the second data from the memory access controller and performs the filtering operation by using the linear interpolation according to the main scaling ratio.

The address controller includes source index information to determine an address of the line memory. The pre-scaling unit further includes a memory interface for storing or reading the first average value to/from the line memory.

Another embodiment of the present invention provides a method of scaling an image, the method including: determining an image scaling ratio (1/N) of first data, wherein the first data is pixel data in each of a plurality of lines; performing a low pass filtering on the first data according to a pre-scaling ratio when the image scaling ratio (1/N) is smaller than or equal to 1/2; and performing a linear interpolation on a result of the low pass filtering according to a main-scaling ratio; and performing a filtering operation on the first data by using a linear interpolation according to the main scaling ratio when the image scaling ratio (1/N) is smaller than 1 and larger than 1/2.

The pre-scaling ratio and the main-scaling ratio are determined by the image scaling ratio (1/N), wherein the image scaling ratio (1/N) is (1/2^{k})×(2^{k}/N) and k and N are integers. The value of 2^{k}/N is satisfied by a condition 2^{k}/N≦1.

Performing the low pass filtering includes: calculating a first average value for every 2^{k} pixel data in each of the lines; storing the first average value of each line; and calculating a second average value for every 2^{k} first average values by reading the first average value.

Performing the linear interpolation on the result of the low pass filtering includes: receiving the second average value and second data; performing the linear interpolation on the second average value and the second data; and storing the second average value as the second data.

Performing the filtering operation on the first data by using the linear interpolation includes: receiving the first data; and performing a linear interpolation on the first data.

In yet another embodiment of the present invention, an image scaling device of a system-on-chip includes: a pre-scaling unit for receiving first data and a pre-scaling ratio; a main scaling unit for receiving a main scaling ratio; and a line memory electrically connected between the pre-scaling unit and the main scaling unit for storing data received from the pre-scaling unit and the main scaling unit, wherein if an image scaling ratio is less than or equal to a first value, the pre-scaling unit low pass filters the first data, outputs the low pass filtered first data, and the main scaling unit performs a linear interpolation on the low pass filtered first data to generate a scaled image according to the main scaling ratio, and if the image scaling ratio is greater than the first value and less than a second value, the first data is directly inputted to the main scaling unit and the main scaling unit performs the linear interpolation on the first data to generate the scaled image according to the main scaling ratio.

The first value of the image scaling ratio is 1/2 and the second value of the image scaling ratio is 1. The pre-scaling ratio and the main-scaling ratio are determined by the image scaling ratio, wherein when the image scaling ratio is (1/N), (1/N) is (1/2^{k})×(2^{k}/N) and k and N are integers.

The value of 2^{k}/N is satisfied by a condition 2^{k}/N≦1. The first data is pixel data in each of a plurality of lines. The low pass filtered first data includes second average values and second data, wherein the second average values are calculated by the pre-scaling unit and are average values of first average values of the pixel data in each of the lines and the second data is the second average values stored in the line memory.

### BRIEF DESCRIPTION OF THE DRAWINGS

The above and other features of the present invention will become more apparent by describing in detail exemplary embodiments thereof with reference to the attached drawings in which:

FIG. 1 is a block diagram of an image scaling device according to an exemplary embodiment of the present invention;

FIG. 2 is a block diagram of a main scaling unit shown in FIG. 1;

FIG. 3 shows an example of sharing a line memory between a pre-scaling unit and the main-scaling unit shown in FIG. 1;

FIG. 4 is a timing diagram showing a time schedule of the pre-scaling unit and the main-scaling unit shown in FIG. 1;

FIG. 5 is a flowchart of a method of scaling an image according to an exemplary embodiment of the present invention;

FIG. 6 is a flowchart of a method of pre-scaling shown in FIG. 5; and

FIG. 7 is a flowchart of a method of main-scaling shown in FIG. 5.

### DETAILED DESCRIPTION OF EXEMPLARY EMBODIMENTS

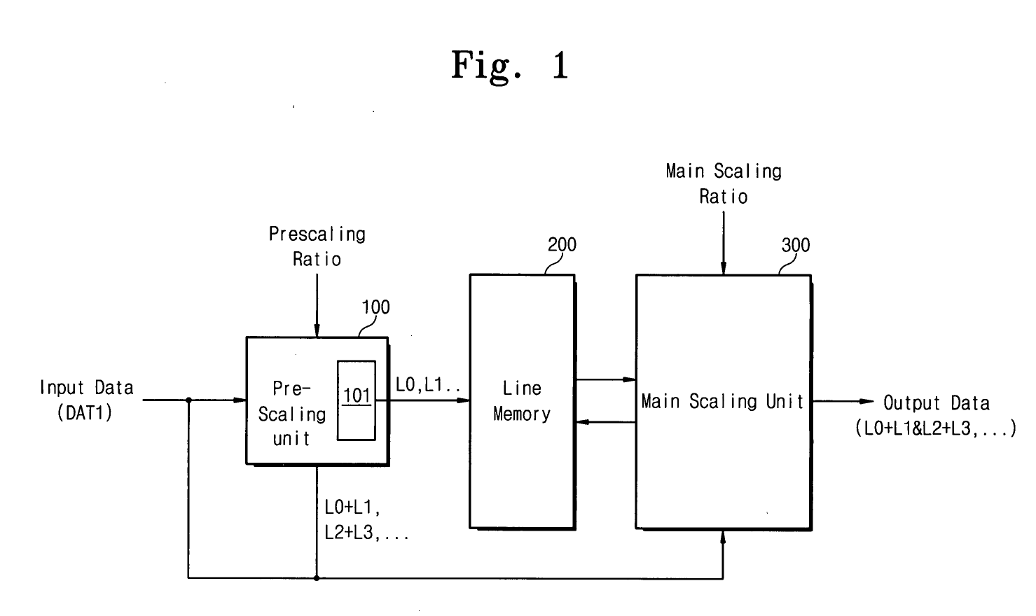

FIG. 1 is a block diagram of an image scaling device according to an exemplary embodiment of the present invention.

Referring to FIG. 1, the image scaling device includes a pre-scaling unit 100, a line memory 200 and a main-scaling unit 300.

The pre-scaling unit 100 performs predetermined processes for low pass filtering first input image data DAT1 according to a pre-scaling ratio inputted from a main processor (not shown). The main processor may be one of a CPU, microprocessor or digital signal processor. Also, the pre-scaling unit 100 includes a memory interface 101 for storing results in the line memory 200 or reading predetermined data from the line memory 200.

The line memory 200 is connected to the pre-scaling unit 100 and the main-scaling unit 300 and stores data input from the pre-scaling unit 100 or the main scaling unit 300.

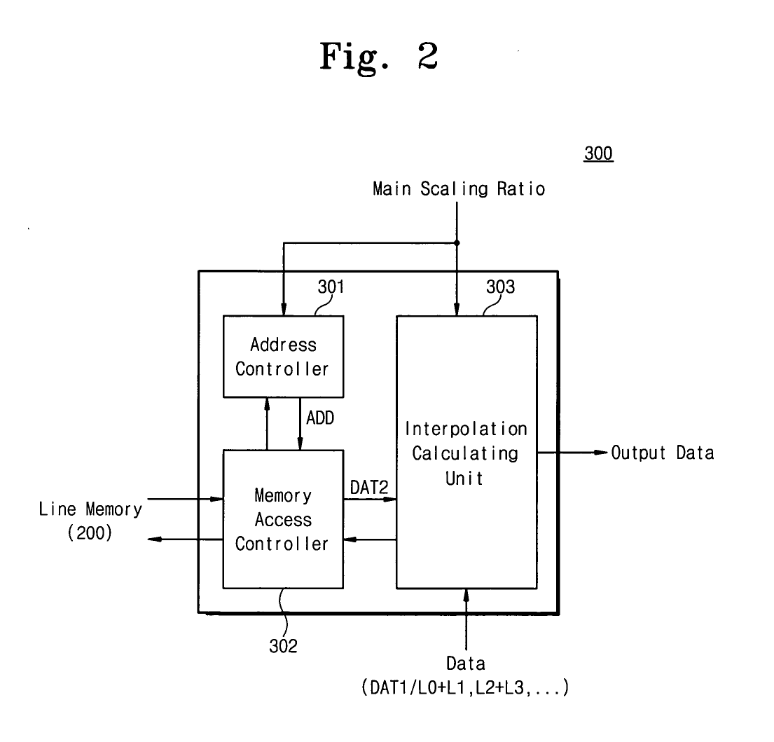

The main scaling unit 300 performs filtering operations based on a main scaling ratio inputted from the main processor. The main-scaling unit 300 will be described in detail with reference to FIG. 2.

FIG. 2 is a block diagram of the main scaling unit 300 shown in FIG. 1.

Referring to FIG. 2, the main scaling unit 300 includes an address controller 301, a memory access controller 302 and an interpolation calculating unit 303.

The address controller 301 includes a source index for calculating an address value (ADD) of the line memory 200 where the data are stored. The address controller 301 receives information about data to be stored or read to/from the line memory 200 and calculates corresponding addresses for storing and reading the data.

The memory access controller 302 receives the address value (ADD) from the address controller 301 and controls the write and read operations between the line memory 200 and the interpolation calculating unit 303.

The interpolation calculating unit 303 receives second data DAT2 that is stored in the line memory 200 and data (L₀30 L₁, L₂+L₃, . . . , Lₙ₋₁+Lₙ) that is inputted from the pre-scaling unit 100, and performs a linear interpolation operation on the second data DAT2 and the data (L₀+L₁, L₂+L₃, . . . , Lₙ₋₁+Lₙ) in response to the main scaling ratio. Alternatively, the interpolation calculating unit 303 receives the first data DAT1 directly from an external memory (not shown) and performs the linear interpolation operation on the first data DAT1 instead of the second data DAT2 received from the pre-scaling unit 100.

The first data DAT1 is pixel data for more than one frame. A single frame is a still image displayed on a display unit such as an LCD in a single image scene. The single frame is configured of pixel data denoting crossings of vertical lines and horizontal lines corresponding to the resolution of the display. For example, if a resolution of a display is 1024×768, a single frame of data includes 1024×768 pixel data which denote image values at crossings of 1024 horizontal lines and 768 vertical lines.

The pre-scaling ratio and the main-scaling ratio are determined by an image scaling ratio (1/N) which is a ratio for scaling down the first data DAT1. The pre-scaling ratio and the main-scaling ratio are calculated according to the image scaling ratio (1/N) by the main processor and are stored in the line memory 200. The stored pre-scaling ratio and the main scaling ratio are transferred to the pre-scaling unit 100 and the main scaling unit 300.

The image scaling ratio (1/N) can be expressed as shown below in Eq. 1.
I/N=(1/2^{k})*(2^{k}/N) [Eq. 1]

In Eq. 1, (2^{k}/N)≦1 and k is an integer smaller than log₂(N) (k≦log₂(N)). Also, k is defined as shown below in Eq. 2.
k=ceiling(log₂(N)) [Eq. 2]

Here, the function ‘ceiling(x)’ returns a smallest integer among integers equal to and smaller than ‘x’.

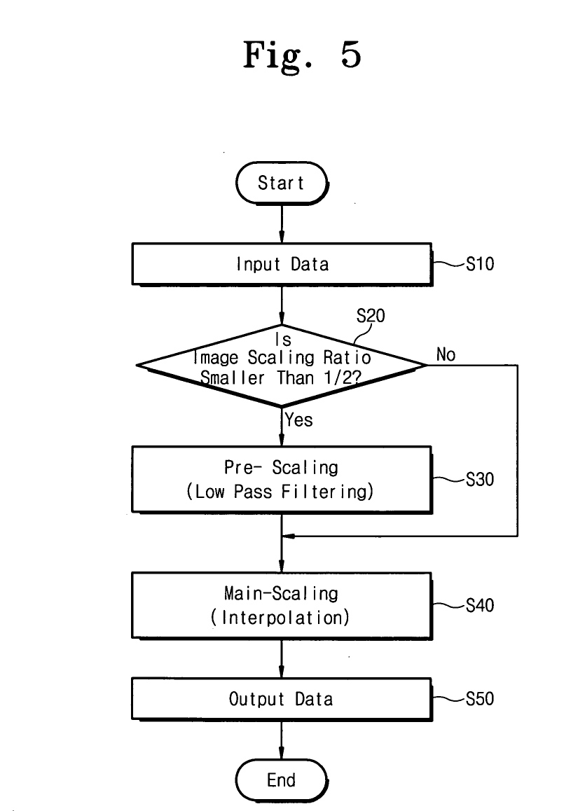

FIG. 5 is a flowchart of a method of scaling an image according to an exemplary embodiment of the present invention.

Referring to FIG. 5, the first data DAT1 is input to the image scaling device in operation S10. Next, it is determined if the image scaling ratio (1/N) is smaller than or equal to 1/2 in operation S20. If the image scaling ratio (1/N) is less than or equal to 1/2 (e.g., 1/N≦1/2), the pre-scaling ratio is not 0. Therefore, the first data DAT1 is processed by performing two image scaling operations. In this case, the first data DAT1 is transferred to the pre-scaling unit 100 for low pass filtering. The pre-scaling unit 100 calculates average values of 2^{k} pixel data for vertical lines and horizontal lines to prevent aliasing in operation S30. Then, the main scaling unit 300 performs the linear interpolation on the result of the pre-scaling unit 100 to generate a scaled image in operation S40. The scaled image is then output as output data (L0+L1&L2+L3, . . . ) in operation S50.

Referring back to operation S20, if the image scaling ratio 1/N is larger than 1/2 and smaller than 1 (e.g., 1/2<1/N<1), the pre-scaling ratio is 0. Therefore, the first data DAT1 is directly transferred to the main-scaling unit 300 without being transferred to the pre-scaling unit 100. In this case, the pre-scaling unit 100 does not process the first data DAT1. The main scaling unit 300 then performs the linear interpolation on the first data DAT1 to generate a scaled image in operation S40. The scaled image is output as the output data (L0+L1&L2+L3, . . . ) in operation S50.

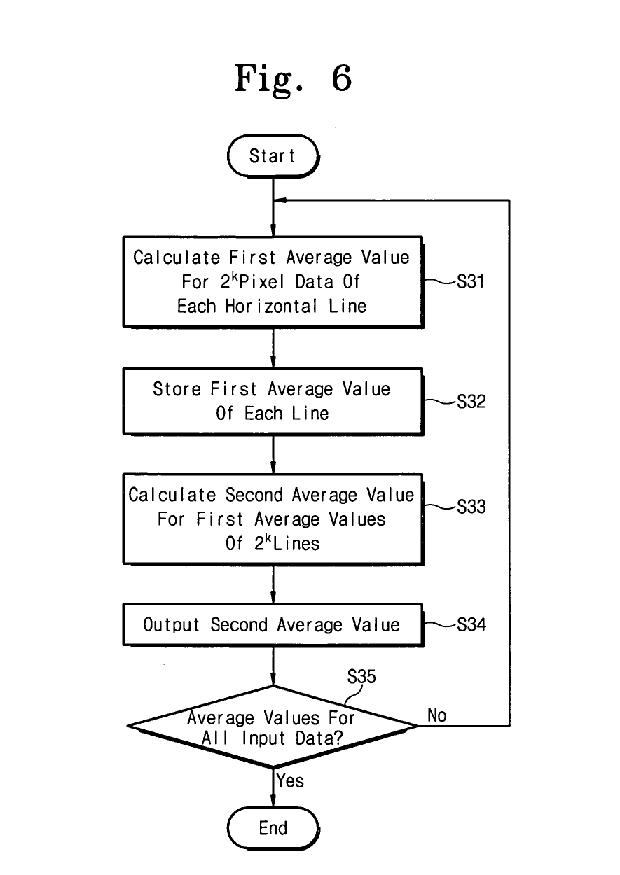

FIG. 4 is a timing diagram showing a time schedule of the pre-scaling unit 100 and the main-scaling unit 300 shown in FIG. 1. For example, FIG. 4 shows the time schedule when k is 1. FIG. 6 is a flowchart of the method of pre-scaling shown in FIG. 5. An image scaling method when the image scaling ratio 1/N is 1/2 will be described hereinafter with reference to FIGS. 4 and 6.

It is to be understood that when the image scaling ratio is 1/2, two steps of an image scaling operation are performed.

Referring now to FIGS. 4 and 6, when the first data DAT1 is inputted from the external memory, the pre-scaling unit 100 calculates first average values of every 2^{k} pixel data on each horizontal line according to the pre-scaling ratio in operation S31. The calculated first average values (L₀, L₁, L₂, . . . , Lₙ) are stored in the line memory 200 in operation S32. For example, when k=1 (e.g., 2^{k}=2), the first average values of every two horizontal lines are stored in the line memory 200.

The pre-scaling unit 100 reads the first average values (L₀, L₁, L₂, . . . , Lₙ) for each of the horizontal lines stored in the line memory 200 and calculates second average values of every 2^{k} first average values in operation S33. The calculated second average values (L₀+L₁, L₂+L₃, . . . Lₙ₋₁+_{Ln}) are outputted to the main scaling unit 300 in operation S34.

For example, when k=1, the pre-scaling unit 100 calculates a first average L₀ of every two pixel data of a first horizontal line and stores the first average L₀ in the line memory 200, and then calculates a first average value L₁ for following input data. After calculating the first average value L₁, the pre-scaling unit 100 reads the first average value L₀ stored in the line memory 200 and calculates a second average value of the two first average values L₀ and L₁. The calculated second average value (L₀+L₁) is outputted to the main scaling unit 300, and the main scaling unit 300 stores the second average value (L₀+L₁) in the line memory 200 as first data.

After outputting the second average value (L₀+L₁), the pre-scaling unit 100 calculates a first average value L₂ of following input data and stores the first average value L₂ in the line memory 200, and calculates another first average value L₃ of following input data. Then, the pre-scaling unit 100 calculates the second average value of two first average values L₂ and L₃. As shown in operation S35, the pre-scaling unit 100 performs the first average calculating operations for all pixel data in every horizontal line.

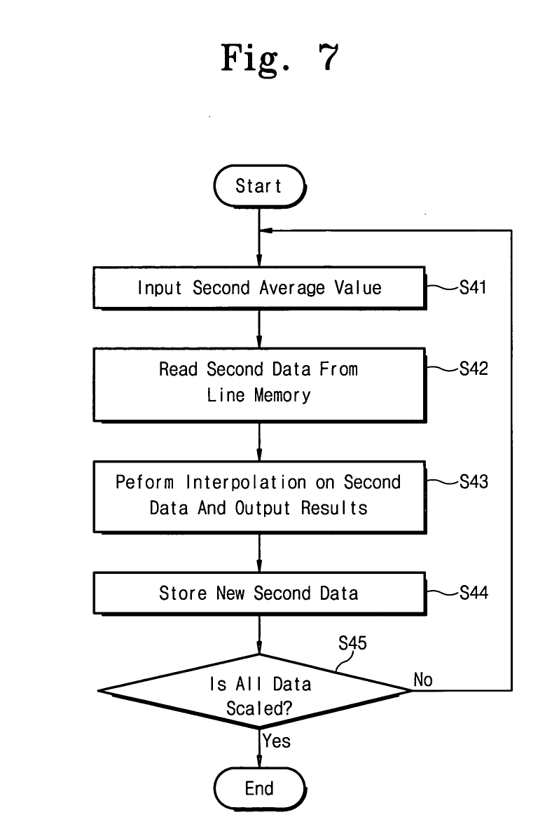

Hereinafter, an operation of the main scaling unit 300 will be described when the image scaling ratio is less than 1/2 with reference to FIGS. 4 and 7. FIG. 7 is a flowchart of the main scaling method shown in FIG. 5.

When the second average values (L₀+L₁, L₂+L₃, . . . , Lₙ₋₁+Lₙ) are inputted to the interpolation calculating unit 303 of the main scaling unit 300 in operation S41, the interpolation calculating unit 303 receives the second data DAT2 stored in the line memory 200 through the memory access controller 302 in operation S42. The second data DAT2 is the second average values (L₀+L₁, L2+L₃, . . . , Lₙ₋₁+Lₙ) stored in the line memory 200 by the main-scaling unit 300 when the main-scaling unit 300 receives the second data DAT2 from the pre-scaling unit 100. The main-scaling unit 300 performs the linear interpolation on the second average values (L₀+L₁, L₂+L₃, . . . , Lₙ₋₁+Lₙ) and the second data DAT2 according to the main scaling ratio in operation S43.

The main-scaling unit 300 outputs the results of the linear interpolation (L₀+L₁ & L₂+L₃, L₂+L₃ & L₄+L₅, . . . , Lₙ₋₃+Lₙ₋₂ & Lₙ₋₁+Lₙ) and stores the second average values (L₀+L₁, L₂+L₃, . . . , Lₙ₋₁+Lₙ) in the line memory 300 through the memory access controller 302 as the second data DAT2 in operation S44. When the main scaling unit 300 receives the second average values (L₀+L₁, L₂+L₃, . . . , Lₙ₋₁+Lₙ) of following pixel data in order, the main scaling unit 300 reads the second data DAT2 from the line memory 200, performs the linear interpolation, and outputs the results. As shown in operation S45, the scaling method performed by the main scaling unit 300 is repeated until all input data are scaled.

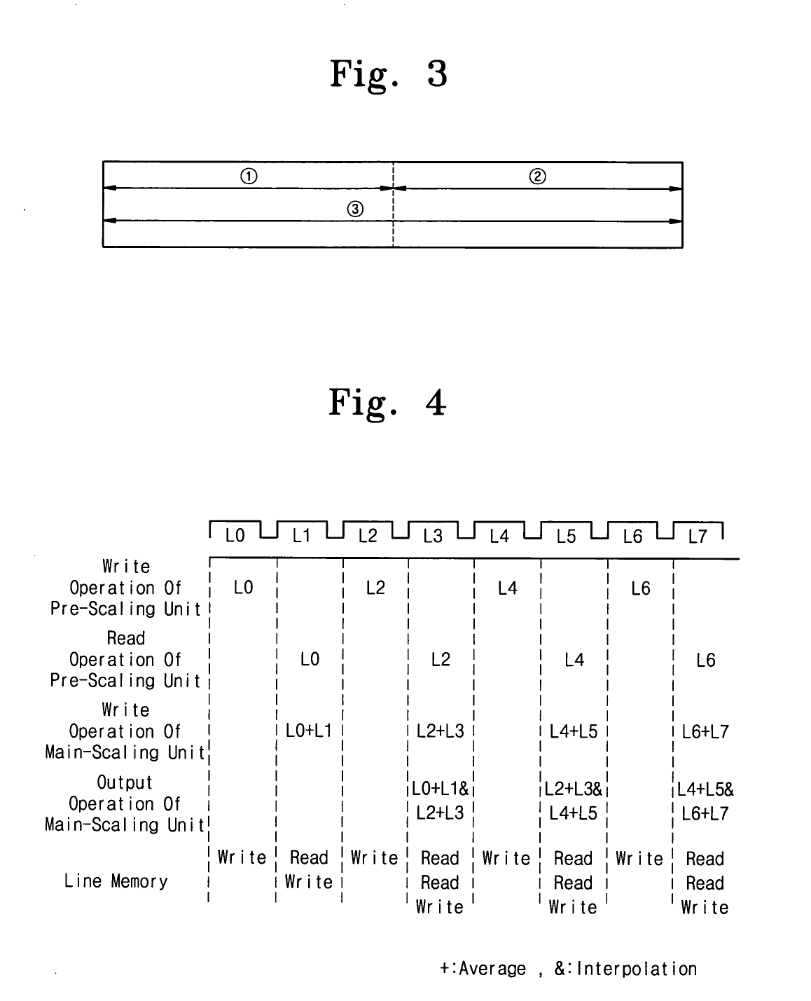

FIG. 3 shows an example of sharing the line memory 200 between the pre-scaling unit 100 and the main-scaling unit 300. Referring to FIG. 3, since the pre-scaling unit 100 calculates the average of 2^{k} pixel data of each horizontal line and stores the average values, the amount of data to be stored in the line memory 200 is reduced by a multiple of, for example, 1/2ⁿ, 1/4ⁿ, 1/8ⁿ . . . 1/2ⁿ. Therefore, the maximum required capacity of the line memory 200 is 1/2 the horizontal resolution (1). For example, if the horizontal resolution is 1024, the line memory 200 can store a maximum of 512 pixel data. Accordingly, the main scaling unit 300 requires a maximum of 1/2 the horizontal resolution (2).

When the image scaling ratio is smaller than 1 and larger than 1/2, the main scaling unit 300 uses the entire storage space of the line memory 300 (3) since the first data DAT1 is directly transferred to the main scaling unit 300.

As described above, the image scaling device and the scaling method according to an exemplary embodiment of the present invention prevent an image from being distorted or aliasing from occurring while the image is scaled down. Also, the single line memory of the image scaling device is commonly used by the pre-scaling unit and the main-scaling unit while scaling down the image, thus improving the integrity of a system-on-chip including the image scaler.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image scaling device, comprising:
a pre-scaling unit for receiving first data of a plurality of M lines each of the M lines having a plurality of L pixel data, calculating a first average value for every 2^{k} pixel data in each of the M lines, and calculating a second average value for every 2^{k} first average values according to a pre-scaling ratio, wherein L, M and k are positive integers;
a line memory for storing the first average value calculated at the pre-scaling unit and second data; and
a main-scaling unit for receiving the second average value from the pre-scaling unit and the second data stored in the line memory and performing a filtering operation on the second average value and the second data by using a linear interpolation according to a main-scaling ratio,
wherein 2^{k} is smaller than a total number of pixel data in one M line and a total number of the M lines.

2. The image scaling device of claim 1, wherein the pre-scaling ratio and the main-scaling ratio are determined by an image scaling ratio (1/N), wherein the image scaling ratio (1/N) is (1/2^{k})×(2^{k}/N) and k and N are integers.

3. The image scaling device of claim 2, wherein 2^{k}/N is satisfied by a condition 2^{k}/N≦1.

4. The image scaling device of claim 3, wherein the main-scaling unit includes:
a memory access controller for storing or reading the second data to/from the line memory;
an address controller for outputting an address of the line memory in response to data information from the memory access controller; and
an interpolation unit for receiving the second data from the memory access controller and the second average value from the pre-scaling unit, performing the filtering operation by using the linear interpolation according to the main scaling ratio and storing the second average value in the line memory as the second data.

5. The image scaling device of claim 4, wherein the first data is directly inputted to the main scaling unit when the image scaling ratio 1/N is smaller than 1 and larger than 1/2.

6. The image scaling device of claim 5, wherein the interpolation unit receives the first data and the second data from the memory access controller and performs the filtering operation by using the linear interpolation according to the main scaling ratio.

7. The image scaling device of claim 4, wherein the address controller includes source index information to determine an address of the line memory.

8. The image scaling device of claim 1, wherein the pre-scaling unit further includes a memory interface for storing or reading the first average value to/from the line memory.

9. A method of scaling an image, comprising:
determining an image scaling ratio (1/N) of first data, wherein the first data is pixel data in each of a plurality of lines;
performing a low pass filtering on the first data according to a pre-scaling ratio when the image scaling ratio (1/N) is smaller than or equal to 1/2; and
performing a linear interpolation on a result of the low pass filtering according to a main-scaling ratio; and
performing a filtering operation on the first data by using a linear interpolation according to the main scaling ratio when the image scaling ratio (1/N) is smaller than 1 and larger than 1/2.

10. The method of claim 9, wherein the pre-scaling ratio and the main-scaling ratio are determined by the image scaling ratio (1/N), wherein the image scaling ratio (1/N) is (1/2^{k})×(2^{k}/N) and k and N are integers.

11. The method of claim 10, wherein 2^{k}/N is satisfied by a condition 2^{k}/N≦1.

12. The method of claim 11, wherein performing the low pass filtering includes:
calculating a first average value for every 2^{k} pixel data in each of the lines;
storing the first average value of each line; and
calculating a second average value for every 2^{k} first average values by reading the first average value.

13. The method of claim 12, wherein performing the linear interpolation on the result of the low pass filtering includes:
receiving the second average value and second data;
performing the linear interpolation on the second average value and the second data; and
storing the second average value as the second data.

14. The method of claim 9, wherein performing the filtering operation on the first data by using the linear interpolation includes:
receiving the first data; and
performing a linear interpolation on the first data.

15. An image scaling device of a system-on-chip, the device comprising:
a pre-scaling unit for receiving first data and a pre-scaling ratio;
a main scaling unit for receiving a main scaling ratio; and
a line memory electrically connected between the pre-scaling unit and the main scaling unit for storing data received from the pre-scaling unit and the main scaling unit, wherein
if an image scaling ratio is less than or equal to a first value, the pre-scaling unit low pass filters the first data, outputs the low pass filtered first data, and the main scaling unit performs a linear interpolation on the low pass filtered first data to generate a scaled image according to the main scaling ratio, and
if the image scaling ratio is greater than the first value and less than a second value, the first data is directly inputted to the main scaling unit and the main scaling unit performs the linear interpolation on the first data to generate the scaled image according to the main scaling ratio.

16. The image scaling device of claim 15, wherein the first value of the image scaling ratio is 1/2 and the second value of the image scaling ratio is 1.

17. The image scaling device of claim 15, wherein the pre-scaling ratio and the main-scaling ratio are determined by the image scaling ratio, wherein when the image scaling ratio is (1/N), (1/N) is (1/2^{k})×(2^{k}/N) and k and N are integers.

18. The image scaling device of claim 17, wherein 2^{k}/N is satisfied by a condition 2^{k}/N≦1.

19. The image scaling device of claim 15, wherein the first data is pixel data in each of a plurality of lines.

20. The image scaling device of claim 19, wherein the low pass filtered first data includes second average values and second data, wherein the second average values are calculated by the pre-scaling unit and are average values of first average values of the pixel data in each of the lines and the second data is the second average values stored in the line memory.
